(19) United States
(12) Patent Application Publication
(10) Pub. No.: US 2026/0318062 A1
(43) Pub. Date: Oct. 15, 2026

(54) Formwork-free and decoration-free cast-in-place structure and construction method therefor

(71) Applicant: Bing ZHONG

(72) Inventor: Bing ZHONG

(21) Appl. No.: 19/111,142

(22) PCT Filed: May 19, 2023
(86) PCT No.: PCT/CN2023/095198

§ 371 Date: Mar. 12, 2025

(30) Foreign Application Priority Data
Sep. 13, 2022 (CN) 202211106806.X

(51) Int. Cl. E04B 1/16; B28B 23/00; E04B 2/86

(52) U.S. Cl. CPC E04B 1/161; E04B 2/8635; B28B 23/005

(57) ABSTRACT

A construction method for a formwork-free and decoration-free cast-in-place structure, comprising multiple cement-based artificial stone slabs with facing, and a metal framework, wherein nuts are embedded in a back of each of the cement-based artificial stone slabs, each of the nuts is in threaded connection with one end of an anchoring connecting rod, the multiple cement-based artificial stone slabs enclose a periphery of the metal framework, concrete is poured into the space enclosed by the plurality of cement-based artificial stone slabs, a main body of the anchoring connecting rod is arranged in the poured concrete, and an anchoring portion is provided on the main body of the anchoring connecting rod.

### TECHNICAL FIELD

The present invention relates to the technical field of buildings, in particular to the formwork-free and decoration-free cast-in-place structure and a construction method therefor.

### BACKGROUND ART

The existing cast-in-place building mainly adopts the following method: firstly, fixing the framework of steel reinforcement made of the reinforcing steel bars on the construction site, then enclosing the framework by formworks made of various materials such as steel, aluminum, wood and the like, after the formworks are completely fixed through various reinforcement members, pouring concrete, disassembling the mold and trimming after the concrete is solidified, and finally, carrying out heat preservation, sound insulation and decoration construction according to requirements to become a finished building for residential use. The existing construction method of the cast-in-place building has the following defects: 1) a large amount of formworks must be used. The cost of the formworks accounts for 20-30% of the cost of the building, accounts for 50% of the construction period, accounts for 30-40% of the workload of the engineering, a large amount of use of the formworks is the main reason that the construction cost of the existing building is too high, meanwhile, the production of various formworks consumes a large amount of resources, according to statistics, the steel formwork which accounts for a relatively small proportion of cast-in-place formworks in Chinese buildings, consumes more than 3 million tons of steel each year, and the steel formworks consume a large amount of energy from ore mining to smelting processing, and generate a large amount of carbon emission; the aluminum formworks that have become popular in recent years not only have high manufacturing cost, but also cause great pollution during the mining and smelting of aluminum; the bamboo and wood formworks, which account for a larger proportion, requires more than 10,000 hectares of forest to be cut down each year to meet demand; the carbon emissions and pollution generated by composite formworks are also quite serious, and the bamboo and wood formworks and the composite formworks are low in strength and easy to be damaged, that a large amount of harmful garbage can be generated. 2) The concrete surface after demolding must be subjected to decoration, heat preservation and sound insulation construction to become a usable finished building, and the prior art has the following defects: firstly, the construction of decoration, heat preservation and sound insulation needs to spend a large amount of manpower and material costs; secondly, existing decorative materials such as coatings, ceramic tiles, stones and the like generally do not meet the green building material standards, some or even completely violate the concept of green building materials. At the same time, there are various defects in the fixed installation of the existing thermal insulation and sound insulation materials. In summary, the existing cast-in-place construction technology must use formworks, must perform decoration and thermal insulation and sound insulation construction, which will have various problems such as low construction efficiency, high construction cost, large waste, excessively high carbon emission and the like.

### SUMMARY OF THE INVENTION

The purpose of the present invention is to provide the formwork-free and decoration-free cast-in-place structure and a construction method therefor to solve the problems raised in the above background art.

The technical solution adopted by the present invention is that a construction method for the formwork-free and decoration-free cast-in-place structure, comprising the following steps:
A. Construction preparation
   1) cement-based artificial stone slabs, made of cement and aggregate as main raw materials, are prepared by vibration as the basic slab preparation technology, the cement-based artificial stone slabs are formed after curing and thickness determination, a front surface of each of the cement-based artificial stone slabs forms a decorative layer by one of peeling, coating, bonding, wrapping, etc.; nuts are embedded in the back of each of the cement-based artificial stone slabs, each of the nuts is in threaded connection with one end of an anchoring connecting rod, and an outer surface of each of the cement-based artificial stone slabs is arranged to be covered with a protective film for later use;
   2) site preparation: laying out lines on site, and fixing reinforcing steel bars to form a metal framework at a construction site;
B. Construction and installation
   1) the multiple cement-based artificial stone slabs enclose on one or more surfaces of a periphery of the metal framework, and the metal framework outside the one or more enclosed surface is enclosed by a formwork; an anchoring portion is provided on the main body of the anchoring connecting rod on the back of each of the cement-based artificial stone slabs, the anchoring portion is of any geometric shape larger than a cross-sectional area of the anchoring connecting rod, and supporting fixing frames are provided on an outside of each of the cement-based artificial stone slabs and the formwork; and
   2) pre-embedding water and electricity pipelines and switch sockets before concrete pouring if they are required to be pre-embedded;
C. Concrete pouring
   1) pouring the concrete on a top portion of the enclosed metal framework, and inserting a slender vibrating rod to vibrate until the pouring is completed to form reinforced concrete;
D. Cleaning completion
   4) dismantling the supporting fixing frames and the enclosed formwork at the construction site;
   5) grouting slab joints between the slabs with structural adhesive; and
   6) cleaning and tearing off the protective film to obtain the formwork-free and decoration-free cast-in-place structure.

Preferably, in Step 1) of the construction preparation Step A, if the cement-based artificial stone slabs are ultra-high-performance artificial stone slabs, raw materials of the artificial stone slabs are configured according to an ultra-high performance standard, and slab preparation technology thereof is prepared by adding intense pressure and vacuumizing as main technical means on the basic technical means of vibration.

Preferably, in Step 1) of the construction preparation Step A, the anchoring connecting rod passes through a thermal insulation material layer, or a sound insulation material layer, or a composite material layer composed of the thermal insulation material layer and the sound insulation material layer, and protrudes from one of the outer ends of the thermal insulation material layer, the sound insulation material layer, or of the composite material layer composed of the thermal insulation material layer and the sound insulation material layer.

Preferably, in Step 1) of the construction preparation Step A, the cement-based artificial stone slabs are arc-shaped or rectangular cement-based artificial stone slabs.

Preferably, in Step 1) of the construction preparation Step A, a mesh is provided in each of the cement-based artificial stone slabs.

Preferably, in Step 1) of the construction and installation Step B, all the peripheries of the metal framework are enclosed by the cement-based artificial stone slabs.

Preferably, in Step 1) of the construction and installation Step B, the anchoring portion and the anchoring connecting rod are of an integrated structure.

Preferably, in Step 1) of the construction and installation Step B, the anchoring portion on the main body of the anchoring connecting rod is connected with the metal framework.

Preferably, in Step 1) of the construction and installation Step B, the anchoring portion is further interconnected with the anchoring connecting rod screwed on the back of another one of the cement-based artificial stone slabs arranged oppositely or with the anchoring portion on the anchoring connecting rod.

Preferably, in Step 1) of the construction and installation Step B, the supporting fixing frames are triangular supporting frames fixed to the ground, and the triangular supporting frames are formed by lap joint according to height requirements and are tightly attached to the surface of each of the cement-based artificial stone slabs.

Preferably, in Step 1) of the construction and installation Step B, the supporting fixing frames are supporting frames or ones formed by fixedly connecting a plurality of horizontal and vertical plane reinforcement members with each other, and each of the plane reinforcement members is a square tube or a channel steel or lumber.

Preferably, in Step 2) of the construction and installation Step B, further comprises erecting a full-hall supporting scaffold, after leveling, laying the cement-based artificial stone slabs on a top portion of the scaffold, and then horizontally placing a framework of steel reinforcement above the cement-based artificial stone slabs, and tying and fixing the placed framework of steel reinforcement with the surrounding framework of steel reinforcements.

The artificial stone slabs of the present invention is made of cement-based materials as the main material, and can adopt the ultra-high performance of the highest standard in the field of concrete as the preparation standard. By adopting the slab preparation method of vibration, intense pressure and vacuumizing, a whole sheet interconnected stainless steel mesh and nuts that can be connected externally are implanted when preparing the slabs. After completing the slab preparation, its surface adopts various finishes formed by the principle of natural stone peeling, so it can fully achieve the service life of more than 100 years of natural stone. When the cement-based artificial stone slab is used as the base slab, the surface can be wrapped with extremely thin metal to achieve any metal finishing effect; wrapping soft finishes such as fabrics and leather can achieve all finishing effects of these materials; the surface of the cement-based artificial stone slab adopts coating treatment to achieve any finishing effect. The excellent performance of the cement-based artificial stone slab itself can reach the highest fireproof, waterproof, and anti-corrosion standards, and can effectively prevent alkali efflux and water seepage. Even if fabrics, wallpaper, etc. are re-pasted on the surface of the slab, the attached finish can achieve an extremely long service life. Therefore, cement-based artificial stone slabs can completely replace existing decorative materials such as coatings, ceramic tiles, stones and the like, can achieve all the decorative effects of these materials inside and outside the building, and can completely solve the various defects commonly found in these materials.

The cement-based artificial stone slab, which has ultra-high strength and ultra-high durability, is combined with a slab preparation method that can make it more dense and have a lower water-cement ratio, and the stainless steel mesh that is interconnected throughout the slab and the nuts that have extremely high hanging strength after forming an integrated body, so that the cement-based artificial stone slab can have extremely high bending, tensile and impact resistance, so it can fully withstand the impact and expansion force generated when pouring concrete, and can completely replace the existing steel, aluminum, wood and other formworks. The strong screw-on hanging force of the embedded nuts on the back of the slab easily and flexibly clamp the thermal insulation material and sound insulation material of any material on the back of the slab through the screw-on embedded anchoring connecting rod. The multifunctional slab formed by physical clamping can solve the various defects of the existing thermal insulation and decorative integrated slabs that are mainly bonded by chemical glue. At the same time, it is also extremely difficult to achieve with existing steel, aluminum, wood and other formworks. The heat insulation and sound insulation materials are clamped and exposed out of one end of the external anchoring connecting rod, and different anchoring portions shall be arranged according to requirements, when used as a formwork to enclose the framework of steel reinforcement, it can be interconnected with the framework of steel reinforcement, or it can be interconnected with the opposite cement-based artificial stone slab, or it can be directly suspended inside or outside the framework of steel reinforcement, and after the artificial stone slab is completely fixed from the periphery by a reinforcement method that is basically same as that of the existing formwork, the expansion force generated by the pouring concrete will be borne and blocked by the peripheral reinforcement. After the concrete is poured, the anchoring portion of the anchoring connecting rod extending at one end of the framework of steel reinforcement will be completely covered, and after the poured concrete is completely solidified, the anchoring portion will be completely wrapped, so that the anchoring portion arranged to be larger than the cross section of the anchoring connecting rod can generate a great drawing force, and meanwhile, the cement-based artificial stone slab completely screwed and interconnected with the anchoring connecting rod can be completely integrated with the cast-in-place reinforced concrete structure. The cement-based artificial stone slab with the trinity of decoration, heat preservation and sound insulation can directly realize the finished building of the trinity function of the cast-in-place building based on the above principle after replacing the formwork for casting.

The present invention adopts cement-based artificial stone slabs to replace the cast-in-place buildings formed by formwork, which can not only reduce the various formwork costs of the existing cast-in-place construction, but also can directly reduce the construction of formwork, demoulding, finishing and decoration, insulation and sound insulation required in the later stage. Not only does it greatly reduce various expenses, but it can also make all cast-in-place buildings directly realize green energy-saving buildings with exquisite internal and external decoration, efficient two-way thermal insulation function, and extremely quiet and healthy indoor environment. Meanwhile, the cement-based ultra-high-performance artificial stone slabs configured with the highest technical standards of cement concrete can fully reach the performance limit of existing cement concrete after adopting the existing ultra-high performance slab preparation methods such as vibration, high pressure and vacuum-pumping, which are extremely difficult to implement. After replacing the formwork and becoming a whole with the entire reinforced concrete structure, the cement-based artificial stone slabs with ultra-high strength above C150 can be used as the overall surface layer of the existing mainly C30 and C40 reinforced concrete structures, which can completely block various erosions and damages caused to the reinforced concrete structure by various harmful substances such as ultraviolet rays and rainwater. Therefore, the service life of the reinforced concrete structure completely protected by cement-based artificial stone slabs can be greatly improved compared with that of the reinforced concrete structure with formwork cast-in-place in the prior art.

The cement-based artificial stone slabs of the present invention adopts waste natural stone as processing scraps, or miscellaneous stones and gravels widely existing in nature that may even affect the growth of crops as main materials, and industrial waste silica fume, mineral powder, fly ash and the like combined with cement as cementitious materials. The production does not require high-temperature firing, does not produce chemical odor, and the waste produced by processing can be reused or made into other building materials, which can fully meet the highest environmental protection standards of zero pollution and zero emission. The cement-based artificial stone slab that does not contain any harmful substances can meet the highest health requirements when used, and can also achieve a variety of beneficial functions such as sterilization, self-cleaning, and air purification after nano or surface nano treatment. The ultra-high strength and ultra-high durability it has can also exceed the high strength and high durability standards of the highest requirements of green building materials, and the slab can be reprocessed into a brand-new facing slab after being dismantled, and it can also be reprocessed into a new product after being broken, which can fully meet the highest standards of green building materials. The present invention adopts the cement-based artificial stone slabs to replace cast-in-place buildings with formwork, which can directly realize green buildings with high efficiency and energy saving. Therefore, the present invention is an innovative technology that benefits the nation and the people.

### DESCRIPTION OF DRAWINGS

FIG. 1 is a structural diagram of the present invention;

FIG. 2 is another structural diagram of the present invention;

FIG. 3 is an enlarged view of Part A in FIG. 2;

FIG. 4 is an enlarged view of Part B in FIG. 2;

FIG. 5 is an enlarged view of Part C in FIG. 2;

FIG. 6 is a schematic diagram of a cast-in-place framework structure of the present invention;

FIG. 7 is a cast-in-place schematic diagram of adding a cast-in-place floor slab to a cast-in-place structure of the present invention;

FIG. 8 is a schematic diagram a cast-in-place shear wall structure with doors or windows of the present invention.

In the drawings: 1—cement-based artificial stone slab; 2—mesh; 3—nut; 4—anchoring connecting rod; 5—thermal insulation material layer; 6—sound insulation material layer; 7—metal framework; 8—reinforced concrete; 9—anchoring portion; and 10—floor slab.

### EMBODIMENTS

Hereinafter, the technical solutions in the embodiments of the present disclosure will be clearly and completely described with reference to the accompanying drawings in the embodiments of the present invention. Obviously, the described embodiments are only part of the embodiments of the present invention, not all of the embodiments. Based on the embodiments of the present invention, all other embodiments obtained by those of ordinary skill in the art without creative work shall fall within the protection scope of the present invention.

### Embodiment 1

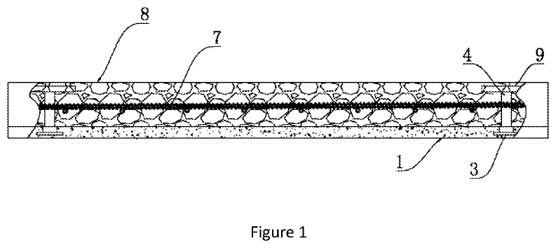

As shown in FIG. 1, when the cast-in-place structure is a cast-in-place wallboard, the metal framework 7 is a framework of steel reinforcement.
A. Construction preparation
   1) cement-based artificial stone slabs 1, made of cement and aggregate as main raw materials, are prepared by vibration as the basic slab preparation technology, the cement-based artificial stone slabs 1 are formed after curing and thickness determination, a front surface of each of the cement-based artificial stone slabs 1 forms a decorative layer by one of peeling, coating, bonding, wrapping, etc.; nuts 3 are embedded in the back of each of the cement-based artificial stone slabs 1, each of the nuts 3 is in threaded connection with one end of an anchoring connecting rod 4, and an outer surface of each of the cement-based artificial stone slabs 1 is arranged to be covered with a protective film for later use;
   2) site preparation: laying out lines on site, and fixing reinforcing steel bars to form a framework of steel reinforcement at a construction site;
B. Construction and installation
   1) the cement-based artificial stone slabs 1 enclose on one surface of the framework of steel reinforcement, and the framework of steel reinforcement outside the enclosed surface is enclosed by a formwork; an anchoring portion 9 is provided on the main body of the anchoring connecting rod 4 on the back of each of the cement-based artificial stone slabs 1, the anchoring portion 9 is of any geometric shape larger than a cross-sectional area of the anchoring connecting rod 4; and supporting fixing frames are provided on an outside of each of the cement-based artificial stone slabs 1;
   2) an L-shaped fixing member can be provided at a bottom portion of an outer side of each of the cement-based artificial stone slabs 1 for reinforcement, one end of the L-shaped fixing member is fixed to the ground with an expansion bolt, and the other end of the L-shaped fixing member is closely attached to each of the cement-based artificial stone slabs 1, the supporting fixing frames provided on the outer side of each of the cement-based artificial stone slabs 1 and the formwork can be triangular supporting frames fixed to the ground, and the triangular supporting frames are formed by lap joint according to height requirements, multiple plane reinforcement members, such as square tubes, channel steels, lumber and the like can be provided between the multiple triangular supporting frames, which are closely attached to the surface of each of the cement-based artificial stone slabs 1;
   3) pre-embedding water and electricity pipelines and switch sockets before concrete pouring if they are required to be pre-embedded;
C. Concrete pouring
   1) pouring the concrete on a top portion of the framework of steel reinforcement that completely encloses and fixes each of the cement-based artificial stone slabs 1, and inserting a slender vibrating rod to vibrate until the pouring is completed to form reinforced concrete 8;
   2) a main body of the anchoring connecting rod 4 is in the reinforced concrete 8, and the anchoring portion 9 can be an integrated structure with the anchoring connecting rod 4; after the reinforced concrete 8 formed by pouring is completely solidified, the huge structural force formed by it will allow the anchoring connecting rod 4 to engage with the anchoring portion 9 thereof, which completely fix each of the cement-based artificial stone slabs 1 and the reinforced concrete 8 into an interconnected whole.
D. Cleaning completion
   1) dismantling the L-shaped fixing member, the triangular supporting frames, and the formwork at the construction site, and repair the ground bolt holes;
   2) grouting slab joints between the slabs with structural adhesive; and
   3) cleaning and tearing off the protective film to obtain the decoration-free cast-in-place wallboard building structure.

### Embodiment 2

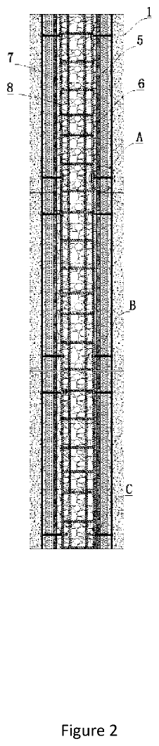

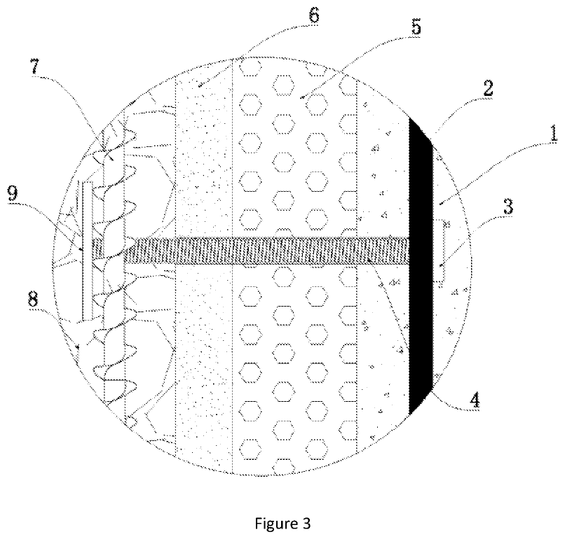

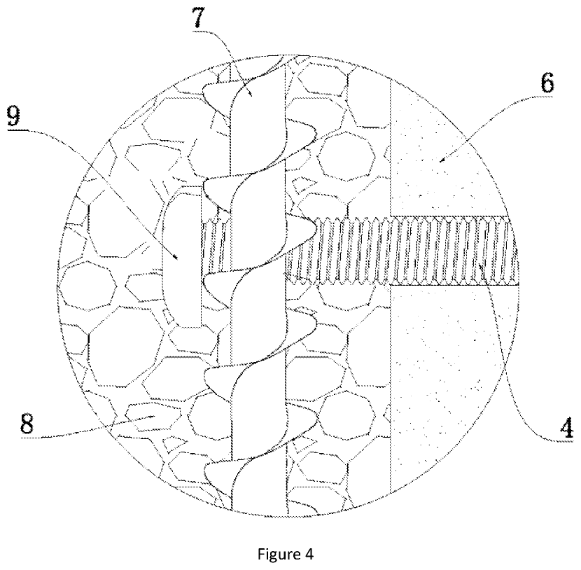

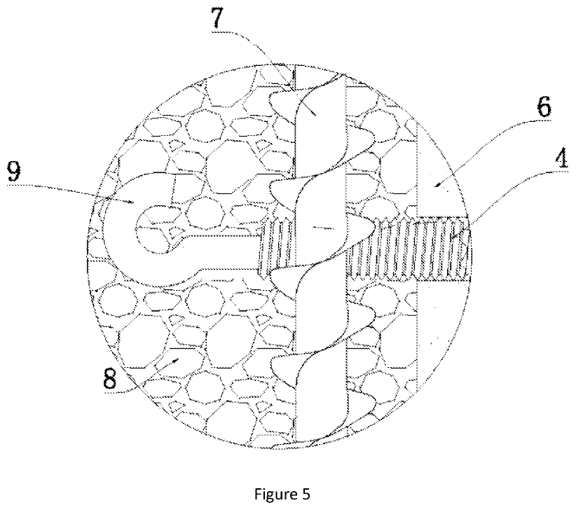

As shown in FIGS. 2 to 5, when the cast-in-place structure is a cast-in-place shear wall structure, the metal framework 7 is a framework of steel reinforcement.
A. Construction preparation
   1) different from the Embodiment 1, in the preparation of the slabs, a mesh 2 is provided in each of the cement-based artificial stone slabs 1, the anchoring connecting rod 4 passes through a thermal insulation material layer 5, or a sound insulation material layer 6, or a composite material layer composed of the thermal insulation material layer 5 and the sound insulation material layer 6, and is screwed with the nuts 3 on the back of each of the cement-based artificial stone slabs 1, so that the back of the cement-based artificial stone board 1 is covered with the thermal insulation material layer 5, or the sound insulation material layer 6, or the composite material layer composed of the thermal insulation material layer 5 and the sound insulation material layer 6; the other end of the anchoring connecting rod 4 protrudes from outer ends of the thermal insulation material layer 5, or the sound insulation material layer 6, or the composite material layer composed of the thermal insulation material layer 5 and the sound insulation material layer 6 according to requirements;
   2) site preparation: laying out lines on site, and fixing reinforcing steel bars to form a framework of steel reinforcement (such as shear wall, etc.) at a construction site;
B. Construction and installation
   1) the cement-based artificial stone slab 1 covered with the thermal insulation material layer 5, or the sound insulation material layer 6, or the composite material layer composed of the thermal insulation material layer 5 and the sound insulation material layer 6 is enclosed inside and outside the framework of steel reinforcement of the shear wall, and two sides thereof are enclosed by the formwork; and a breathable waterproof membrane can be penetrated on the anchoring connecting rod 4 on the back of the cement-based artificial stone slab 1 according to requirements, an anchoring portion 9 is provided on the main body of the anchoring connecting rod 4 on the back of each of the cement-based artificial stone slabs 1, the anchoring portion 9 is of any geometric shape larger than a cross-sectional area of the anchoring connecting rod 4; and it can also be interconnected with the anchoring connecting rod 4 screwed on the back of another one of the cement-based artificial stone slabs arranged oppositely or the anchoring portion 9 on the anchoring connecting rod 4, and supporting fixing frames are provided on an outside of each of the cement-based artificial stone slabs 1;
   2) an L-shaped fixing member can be provided at an inner and outer bottom portion of each of the cement-based artificial stone slabs 1 for reinforcement, one end of the L-shaped fixing member is fixed to the ground with an expansion bolt, and the other end of the L-shaped fixing member is closely attached to each of the cement-based artificial stone slabs 1, the supporting fixing frames provided on the outer side of each of the cement-based artificial stone slabs 1 and the formwork can be triangular supporting frames fixed to the ground, and the triangular supporting frames are formed by lap joint according to height requirements, multiple plane reinforcement members, such as square tubes, channel steels, lumber and the like can be provided between the multiple triangular supporting frames, which are closely attached to the surface of each of the cement-based artificial stone slabs 1;
   3) pre-embedding water and electricity pipelines and switch sockets before concrete pouring if they are required to be pre-embedded;
C. Concrete pouring
   1) pouring the concrete on a top portion of the framework of steel reinforcement that completely encloses and fixes each of the cement-based artificial stone slabs 1, and inserting a slender vibrating rod to vibrate until the pouring is completed to form reinforced concrete 8;
   2) a main body of the anchoring connecting rod 4 is in the reinforced concrete 8, and the anchoring portion 9 can be an integrated structure with the anchoring connecting rod 4; after the reinforced concrete 8 formed by pouring is completely solidified, the huge structural force formed by it will allow the anchoring connecting rod 4 to engage with the anchoring portion 9 thereof, which completely fix each of the cement-based artificial stone slabs 1 and the reinforced concrete 8 into an interconnected whole.
D. Cleaning completion
   1) dismantling the L-shaped fixing member, the triangular supporting frames, and the formwork at the construction site, and repair the ground bolt holes;
   2) grouting slab joints between the slabs with structural adhesive; and
   3) cleaning and tearing off the protective film to obtain a decoration-free cast-in-place shear wall building structure with decorative, thermal insulation, and sound insulation functions inside and outside.

### Embodiment 3

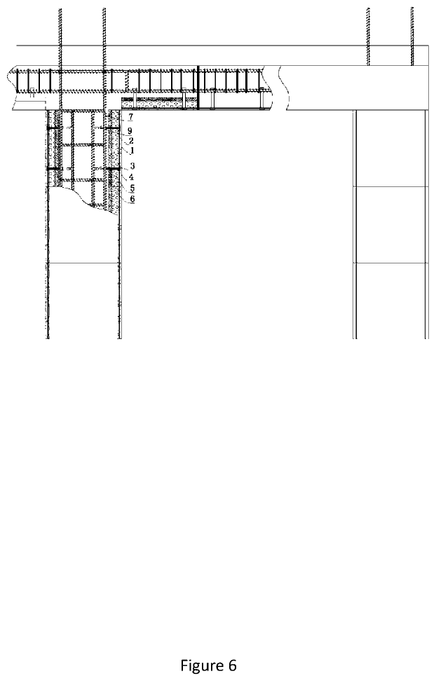

As shown in FIG. 6, when the cast-in-place structure is a cast-in-place frame structure, the mesh 2 is a stainless steel mesh, the metal framework 7 is a framework of steel reinforcement, and the cement-based artificial stone slabs 1 are cement-based ultra-high-performance artificial stone slabs.
A. Construction preparation
   1) the cement-based ultra-high-performance artificial stone slabs are made of cement and aggregate as main raw materials and configured according to ultra-high performance standards, the slab preparation technology thereof is based on the basic technical means of vibration, and is prepared by adding intense pressure and vacuumizing as the main technical means, the cement-based ultra-high-performance artificial stone slabs are formed after curing and thickness determination; a front surface of the cement-based artificial stone slab forms a decorative layer by one of peeling, coating, bonding, wrapping, etc.; a stainless steel mesh is provided in the cement-based ultra-high-performance artificial stone slab, and nuts 3 are embedded in the back of the cement-based ultra-high-performance artificial stone slab, each of the nuts 3 is in threaded connection with one end of an anchoring connecting rod 4, and an outer surface of each of the cement-based ultra-high-performance artificial stone slab is arranged to be covered with a protective film for later use;
   2) site preparation: laying out lines on site, and fixing reinforcing steel bars to form a framework of steel reinforcement (such as columns, beams, etc.) at a construction site;
B. Construction and installation
   1) cement-based ultra-high-performance artificial stone slabs are protected around an outer periphery of the framework of steel reinforcement of the column, the cement-based ultra-high-performance artificial stone slabs are rectangular cement-based ultra-high-performance artificial stone slabs, the supporting fixing frames are arranged on the outsides of the cement-based ultra-high-performance artificial stone slabs, the supporting fixing frames are supporting frames or ones formed by fixedly connecting a plurality of horizontal and vertical plane reinforcement members with each other, and the supporting fixing frames are formed by lap joint according to height requirements, and each of the plane reinforcement members is a square tube or a channel steel or lumber.
   2) when cement-based ultra-high-performance artificial stone slabs are arc-shaped cement-based ultra-high-performance artificial stone slabs, they can be reinforced with a hoop;
   3) erecting a full-hall supporting scaffold, after leveling, laying the cement-based ultra-high-performance artificial stone slabs on a top portion of the scaffold, and then horizontally placing a framework of steel reinforcement above the cement-based ultra-high-performance artificial stone slabs to form a beam reinforcement framework, wherein a front portion and a rear portion of the beam reinforcement framework are enclosed by the cement-based ultra-high-performance artificial stone slabs, and a left end and a right end of the beam reinforcement framework are respectively tied and fixed to the top ends of the two column frameworks of steel reinforcement.
   4) pre-embedding water and electricity pipelines and switch sockets before concrete pouring if they are required to be pre-embedded;
C. Concrete pouring
   1) pouring concrete above the column metal framework, and then sequentially pouring concrete above the beam metal framework, wherein during pouring, inserting a slender vibrating rod to vibrate until the pouring is completed to form reinforced concrete 8;
   2) a main body of the anchoring connecting rod 4 is in the reinforced concrete 8, an anchoring portion 9 is provided on the main body of the anchoring connecting rod 4, the anchoring portion 9 is of any geometric shape larger than a cross-sectional area of the anchoring connecting rod 4, and the anchoring portion 9 can be an integrated structure with the anchoring connecting rod 4; after the reinforced concrete 8 formed by pouring is completely solidified, the huge structural force formed by it will allow the anchoring connecting rod 4 to engage with the anchoring portion 9 thereof, which completely fix the cement-based ultra-high-performance artificial stone slabs and the reinforced concrete 8 into an interconnected whole.
D. Cleaning completion
   1) dismantling the supporting fixing frames, the full-hall supporting scaffold, and the formwork at the construction site;
   2) grouting slab joints between the slabs with structural adhesive; and
   3) cleaning and tearing off the protective film to obtain the multi-functional cast-in-place framework structure.

### Embodiment 4

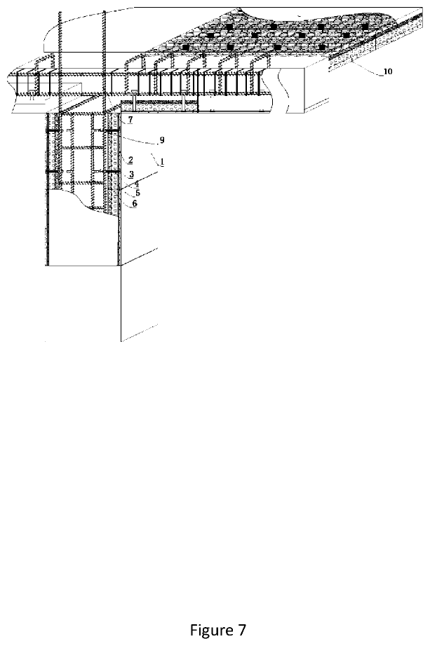

The floor slabs of various cast-in-place structures are cast-in-place, and the metal framework 7 is a framework of steel reinforcement.
A. Construction preparation
   The construction preparation is the same as that in Embodiment 1;
B. Construction and installation
   1) erecting a full-hall supporting scaffold, after leveling, laying the cement-based artificial stone slab 1 covered with the thermal insulation material layer 5, or the sound insulation material layer 6, or the composite material layer composed of the thermal insulation material layer 5 and the sound insulation material layer 6 on a top portion of the scaffold, and then horizontally arranging a framework of steel reinforcement that is staggered horizontally and vertically to form a floor slab 10 (as shown in FIG. 7) on the cement-based artificial stone slab 1, the ends of the framework of steel reinforcement of the floor slab 10 are connected with the framework of steel reinforcement of the shear wall or the framework of steel reinforcement of the beam and column in a penetrating way, and are tied and fixed thereto;
   2) pre-embedding water and electricity pipelines and switch sockets before concrete pouring if they are required to be pre-embedded;
C. Concrete pouring
   1) pouring the stirred concrete above the floor slab framework of steel reinforcement, wherein during pouring, inserting a slender vibrating rod to vibrate until the pouring is completed to form reinforced concrete 8;
   2) a main body of the anchoring connecting rod 4 is in the reinforced concrete 8, an anchoring portion 9 is provided on the main body of the anchoring connecting rod 4, the anchoring portion 9 is of any geometric shape larger than a cross-sectional area of the anchoring connecting rod 4, and the anchoring portion 9 can be an integrated structure with the anchoring connecting rod 4; after the reinforced concrete 8 formed by pouring is completely solidified, the huge structural force formed by it will allow the anchoring connecting rod 4 to engage with the anchoring portion 9 thereof, which completely fix the cement-based artificial stone slabs and the reinforced concrete 8 into an interconnected whole.
D. Cleaning completion
   1) dismantling the full-hall supporting scaffold at the construction site;
   2) grouting slab joints between the slabs with structural adhesive; and
   3) cleaning and tearing off the protective film to obtain a multi-faceted decoration-free cast-in-place floor structure.

### Embodiment 5

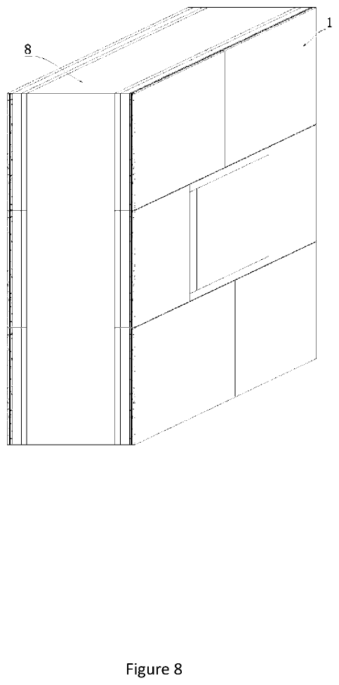

As shown in FIG. 8, when the cast-in-place structure is a cast-in-place shear wall structure with doors or windows, the cement-based artificial stone slabs 1 are cement-based ultra-high-performance artificial stone slabs.
A. Construction preparation
   1) the cement-based ultra-high-performance artificial stone slabs are made of cement and aggregate as main raw materials and configured according to ultra-high performance standards, the slab preparation technology thereof is based on the basic technical means of vibration, and is prepared by adding intense pressure and vacuumizing as the main technical means, the cement-based ultra-high-performance artificial stone slabs are formed after curing and thickness determination; a front surface of the cement-based ultra-high-performance artificial stone slab forms a decorative layer by one of peeling, coating, bonding, wrapping, etc.; a mesh 2 is provided in the cement-based ultra-high-performance artificial stone slab, and nuts 3 are embedded in the back of the cement-based ultra-high-performance artificial stone slab, each of the nuts 3 is in threaded connection with one end of an anchoring connecting rod 4, one end of the anchoring connecting rod passes through a thermal insulation material layer 5, or a sound insulation material layer 6, or a composite material layer composed of the thermal insulation material layer 5 and the sound insulation material layer 6, and is screwed with the nuts 3 on the back the cement-based ultra-high-performance artificial stone slab; the other end of the anchoring connecting rod 4 protrudes from outer ends of the thermal insulation material layer 5, or the sound insulation material layer 6, or the composite material layer composed of the thermal insulation material layer 5 and the sound insulation material layer 6 according to requirements, and an outer surface of each of the cement-based ultra-high-performance artificial stone slab is arranged to be covered with a protective film for later use;
   2) site preparation: laying out lines on site, and fixing reinforcing steel bars to form a framework of steel reinforcement (such as columns, beams, etc.), and reserving positions for doors or windows (such as cast-in-place shear walls with doors or windows, etc.) at a construction site;
B. Construction and installation
   1) the cement-based ultra-high-performance artificial stone slab covered with the thermal insulation material layer 5, or the sound insulation material layer 6, or the composite material layer composed of the thermal insulation material layer 5 and the sound insulation material layer 6 is installed around the outer periphery of the framework of steel reinforcement of the shear wall; and a breathable waterproof membrane can be penetrated on the anchoring connecting rod 4 on the back of the cement-based ultra-high-performance artificial stone slab according to requirements, an anchoring portion 9 is provided on the main body of the anchoring connecting rod 4 on the back of the cement-based ultra-high-performance artificial stone slab, the anchoring portion 9 is of any geometric shape larger than a cross-sectional area of the anchoring connecting rod 4; and it can also be interconnected with the anchoring connecting rod 4 screwed on the back of the another cement-based ultra-high-performance artificial stone slab arranged oppositely or the anchoring portion 9 on the anchoring connecting rod 4, and supporting fixing frames are provided on an outside of the cement-based ultra-high-performance artificial stone slab;
   2) an L-shaped fixing member can be provided at an inner and outer bottom portion of the cement-based ultra-high-performance artificial stone slab for reinforcement, one end of the L-shaped fixing member is fixed to the ground with an expansion bolt, and the other end of the L-shaped fixing member is closely attached to the cement-based ultra-high-performance artificial stone slab, the supporting fixing frames provided on the outer side of the cement-based ultra-high-performance artificial stone slabs and the formwork can be triangular supporting frames fixed to the ground, and the triangular supporting frames are formed by lap joint according to height requirements, multiple plane reinforcement members, such as square tubes, channel steels, lumber and the like can be provided between the multiple triangular supporting frames, which are closely attached to the surface of the cement-based ultra-high-performance artificial stone slab;
   3) the door and window portions can connect the plurality of cement-based ultra-high-performance artificial stone slabs at the guide corners in series through long steel bars, and then threadedly connected with the nuts 3 on the back of each of the cement-based ultra-high-performance artificial stone slabs on both sides. Specifically, placing the long steel bars on the back of the plurality of cement-based ultra-high-performance artificial stone slabs, and fixing them by passing the anchoring connecting rod 4 through the screw holes on the long steel bars, and threadedly connecting them with the nuts 3 on the back of the cement-based ultra-high-performance artificial stone slabs on the sides, wherein the long steel bars can be bent at a certain angle as needed to achieve different shapes and structures, and are clamped and fixed on the opening surface of the door or window through the reinforcement members;
   4) pre-embedding water and electricity pipelines and switch sockets before concrete pouring if they are required to be pre-embedded.

Step C of concrete pouring and Step D of cleaning completion are all the same as those in Embodiment 1; and finally, a cast-in-place shear wall structure with doors or windows for decoration, heat preservation and sound insulation functions is obtained.

It will be apparent to those skilled in the art that the present invention is not limited to the details of the exemplary embodiments described above, and that the present invention can be embodied in other specific forms without departing from the spirit or essential characteristics of the invention. Therefore, regardless of which point the embodiments should be considered as exemplary and not restrictive, the scope of the invention is defined by the appended claims rather than by the foregoing description, and therefore, it is intended that all changes that come within the meaning and range of equivalency of the claims shall be embraced within the present invention. Any reference signs in the claims shall not be regarded as limiting the involved claims.

1. A construction method for a formwork-free and decoration-free cast-in-place structure, comprising the following steps:
A. Construction preparation
1) cement-based artificial stone slabs (1), made of cement and aggregate as main raw materials, are prepared by vibration as the basic slab preparation technology, the cement-based artificial stone slabs are formed after curing and thickness determination, a front surface of each of the cement-based artificial stone slabs (1) forms a decorative layer by one of peeling, coating, bonding, wrapping, etc.; nuts (3) are embedded in the back of each of the cement-based artificial stone slabs (1), each of the nuts (3) is in threaded connection with one end of an anchoring connecting rod (4), and an outer surface of each of the cement-based artificial stone slabs (1) is arranged to be covered with a protective film for later use;
2) site preparation: laying out lines on site, and fixing reinforcing steel bars to form a metal framework (7) at a construction site;
B. Construction and installation
1) the multiple cement-based artificial stone slabs (1) enclose on one or more surfaces of a periphery of the metal framework (7), and the metal framework (7) outside the one or more enclosed surface is enclosed by a formwork; an anchoring portion (9) is provided on the main body of the anchoring connecting rod (4) on the back of each of the cement-based artificial stone slabs (1), the anchoring portion (9) is of any geometric shape larger than a cross-sectional area of the anchoring connecting rod (4), and supporting fixing frames are provided on an outside of each of the cement-based artificial stone slabs (1) and the formwork; and
2) pre-embedding water and electricity pipelines and switch sockets before concrete pouring if they are required to be pre-embedded;
C. Concrete pouring
1) pouring the concrete on a top portion of the enclosed metal framework (7), and inserting a slender vibrating rod to vibrate until the pouring is completed to form reinforced concrete (8);
D. Cleaning completion
1) dismantling the supporting fixing frames and the enclosed formwork at the construction site;
2) grouting slab joints between the slabs with structural adhesive; and
3) cleaning and tearing off the protective film to obtain the formwork-free and decoration-free cast-in-place structure.

2. The construction method for a formwork-free and decoration-free cast-in-place structure according to claim 1, wherein in Step 1) of the construction preparation Step A, if the cement-based artificial stone slabs (1) are ultra-high-performance artificial stone slabs, raw materials of the artificial stone slabs are configured according to an ultra-high-performance standard, and slab preparation technology thereof is prepared by adding intense pressure and vacuumizing as main technical means on the basic technical means of vibration.

3. The construction method for a formwork-free and decoration-free cast-in-place structure according to claim 1, wherein in Step 1) of the construction preparation Step A, the anchoring connecting rod (4) passes through one of the thermal insulation material layer (5), a sound insulation material layer (6), or a composite material layer composed of the thermal insulation material layer (5) and the sound insulation material layer (6), and protrudes from one of the outer ends of the thermal insulation material layer (5), the sound insulation material layer (6), or of the composite material layer composed of the thermal insulation material layer (5) and the sound insulation material layer (6).

4. The construction method for a formwork-free and decoration-free cast-in-place structure according to claim 1, wherein in Step 1) of the construction and installation Step B, all the peripheries of the metal framework (7) are enclosed by the cement-based artificial stone slabs (1).

5. The construction method for a formwork-free and decoration-free cast-in-place structure according to claim 1, wherein in Step 1) of the construction and installation Step B, the anchoring portion (9) and the anchoring connecting rod (4) are of an integrated structure.

6. The construction method for a formwork-free and decoration-free cast-in-place structure according to claim 1, wherein in Step 1) of the construction and installation Step B, the anchoring portion (9) on the main body of the anchoring connecting rod (4) is connected with the metal framework (7).

7. The construction method for a formwork-free and decoration-free cast-in-place structure according to claim 1, wherein in Step 1) of the construction and installation Step B, the anchoring portion (9) is further interconnected with the anchoring connecting rod (4) screwed on the back of another one of the cement-based artificial stone slabs arranged oppositely or with the anchoring portion (9) on the anchoring connecting rod (4).

8. The construction method for a formwork-free and decoration-free cast-in-place structure according to claim 1, wherein in Step 1) of the construction and installation Step B, the supporting fixing frames are triangular supporting frames fixed to the ground, and the triangular supporting frames are formed by lap joint according to height requirements and are tightly attached to the surface of each of the cement-based artificial stone slabs (1).

9. The construction method for a formwork-free and decoration-free cast-in-place structure according to claim 1, wherein in Step 1) of the construction and installation Step B, the supporting fixing frames are supporting frames or ones formed by fixedly connecting a plurality of horizontal and vertical plane reinforcement members with each other, and each of the plane reinforcement members is a square tube or a channel steel or lumber.

10. The construction method for a formwork-free and decoration-free cast-in-place structure according to claim 1, wherein in Step 2) of the construction and installation Step B, further comprises erecting a full-hall supporting scaffold, after leveling, laying the cement-based artificial stone slabs (1) on a top portion of the scaffold, and then placing a framework of steel reinforcement above the cement-based artificial stone slabs (1), and tying and fixing the placed framework of steel reinforcement with the surrounding framework of steel reinforcements.
